(19) United States
(12) Patent Application Publication
(10) Pub. No.: US 2005/0146606 A1
(43) Pub. Date: Jul. 7, 2005

(54) Remote video queuing and display system

(76) Inventors: Yaakov Karsenty, Nataf (IL); Dave Scott, Fontana, CA (US)

Correspondence Address: Alex Chartove;Morrison & Foerster LLP, Suite 300, 1650 Tysons Blvd., McLean, VA, 22102, US

(21) Appl. No.: 10/703,073

(22) Filed: Nov. 7, 2003

(51) Int. Cl. H04N 7/18

(52) U.S. Cl. 348/143

(57) ABSTRACT

The invention relates to a system and method for monitoring the status at a remote site from a control center. In one embodiment, the present system uses a client/server approach to security by having a client at a remote site monitor video, audio, and other sensor information and forward it to a server operated at a command center. By monitoring for various sorts of activity, the system can automatically alert an operator as to developing conditions at the remote site, contact local personnel, and, if so configured, alert law enforcement authorities or emergency personnel. When an alarm condition arises, the server will automatically provide the operator in the control center with live or still video feed from the remote site in a “pop-up” window with a color-coded outline to indicate the status of the remote site. A topographical map of the site may also be displayed, to enable local authorities to track an intruder or quickly locate the source of the alarm. Through a unique video queuing method, the present system allows operators in a command center to easily and quickly monitor the status of events at a large number of remote locations.

### FIELD OF THE INVENTION

The present invention relates to a remote video monitoring system wherein a control center collects a “site status”, i.e., the status of all the sensors at a remote site, audio and visual information from remote sites. The remote sites are connected to the control center via a distributed network and have client software and audiovisual monitoring equipment operating on a computer. The control center includes server software and provides a central host with the ability to monitor activity at the remote sites and to automatically receive warnings when preset conditions exist at the remote site.

### BACKGROUND OF THE INVENTION

The field of video monitoring and surveillance has typically employed video cameras and other monitoring equipment that would be attended to by on-site security or maintenance personnel. For example, a security guard in a specified location would watch video screens to monitor the premises of a building, hotel, or other establishment. While such a system permits fewer security personnel to maintain control over relatively large premises, prior art systems did not include means for monitoring the status of multiple sites simultaneously, allow for the system operator to receive alerts from the monitoring equipment to immediately notify them when a preset condition had been met, such as the loss of signal from a monitoring location, activity within a location, etc. Further, prior art systems did not permit the operator to remotely view video feed from off-site locations over a distributed network, nor to control the video equipment, video recorders, closed-circuit television surveillance equipment, video switches, and other related equipment from their remote location.

It is therefore desirable to overcome the above-mentioned failings of the prior art by permitting the creation of a remote control center with the capability of monitoring a large number of remote sites. It is also desirable for the control center operator to receive alerts when preset conditions arise and to be able to remotely queue video and control the audiovisual equipment from the control center.

Another aspect of prior art system that may be overcome is the need to use expensive, proprietary video surveillance and monitoring equipment. It would be desirable for a remote video monitoring and surveillance system to be compatible with a wide variety of “off the shelf” and other components that can be connected to a standard personal computer. The system may also permit the use of the remote video equipment to be used for video conferencing and other similar purposes.

### SUMMARY OF THE INVENTION

In one embodiment, the invention is method for monitoring the status of events at a remote site. The method includes establishing a connection between a local host and a client at a remote site, providing at least one sensor at the remote site, monitoring the status of the sensor by the client, capturing audio, video, or both by the sensor, transmitting the status of the sensor from the client to the local host, transmitting audio, video, or both from the client to the local host, displaying the status of the sensor on a monitor screen by the local host, and automatically displaying live video feed, still video feed, audio feed, or any combination thereof, in a pop-up window on the monitor screen when an alarm condition has been detected by the sensor.

The method may also allow for the local host to establish connections with clients at a plurality of remote sites and queue video, audio, or both transmitted from the clients at the plurality of remote sites to the local host. Also, the server may display a pop-up window that includes a color-coded outline to indicate the status of the sensor at the remote site.

The method may create a connection between the local host and the client at the remote site that is established over a distributed network. The distributed network may use the TCP/IP protocol. In one embodiment the distributed network is the internet.

The method also may allow for the setting of an alarm condition when the connection between the local host and the client at the remote site cannot be established. The system may determine whether an alarm condition that has been set actually exists by reviewing the audio, video, or both transmitted from the client at the remote site. Also, the alarm condition may be cleared if it is determined from the audio, video, or both that the alarm condition was erroneously set. Final, the system may display a topographical map of a remote site where an alarm condition has been transmitted to the local host.

In another embodiment, the system for remote monitoring and surveillance includes a host computer having server software operating thereon, a remote terminal at a remote site having client software operating thereon, a distributed network for transmitting data between the host computer and the remote terminal, a hardware card installed in the remote terminal for receiving audio and/or video data and status information; and a sensor for transmitting audio and/or video and status information to the hardware card in the remote terminal. Preferably, the server software installed on the host computer processes information received from the client computer via the distributed network to determine the status perceived by the sensor and displays the status on the screen display, and when the status perceived by the sensor triggers an alarm, the status of the sensor is automatically displayed on the screen display.

### BRIEF DESCRIPTION OF THE DRAWING FIGURES

FIG. 1 is an illustrative screen shot and illustration showing the display screen at the command center with a topographical diagram indicating how the command center is in communication with multiple remote sites.

FIG. 2 is a topographical map of a remote site showing sensor locations.

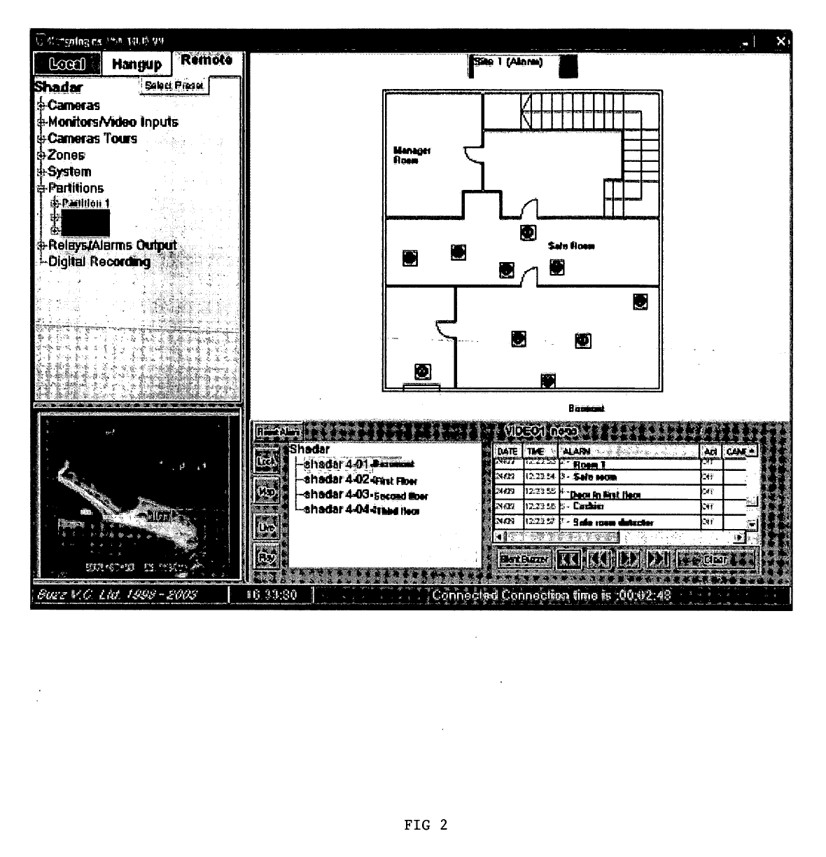

### DETAILED DESCRIPTION OF THE INVENTION

A building (Like school, office, store and so on) that his being controlled by a control center. A typical site will have Cameras, sensors, PC with Buzz card and software installed, and any other CCTV equipment, such as a VCR, multiplexer, etc. For purposes of the present invention, this can be called the client (where the client software is operator) and constitutes a remote site for monitoring.

The Control Center (CC) may comprise a room or location that contains the equipment and computers running the server software that collects data from the remote sites and allows the operators to monitor the remote sites. This location would generally be attended 24 hours a day. In case of an alarm event the remote site may notify the control center, and the operators in the control center would take action according to predefined instruction. Those instructions might be to alert a police patrol to the site, call an emergency number (owners of the building, etc.), or take some other predefined action.

An alarm event/situation may be defined as when a remote site indicates that an alarm occurred that has not yet been handled by the control center yet. Possible reasons for the alarms—an alarm sensor has detected an intruder, an alarmed door has been opened, a fence sensor has detected that someone is climbing the fence, a video motion detector has sensed movement, etc.

The present system (server software) may be installed in the control center (CC) and interact with all the remote sites thru modifications made in the remote monitoring software (client software). For each site that is controlled by the control center, the system may check the status of the site at preset time intervals, whenever that the remote site is “online”. A remote site is online when a signal (message), has been received from the remote site. If the remote site remain “silent” for more than a predefined period of time, i.e., a minute for example, the remote site is put under an “alarm condition”.

To determine when an alarm condition exists, the system may also periodically check the alarms sensors in the remote site, this may include the monitoring of video equipment, audio equipment, and conduct frame analysis of the video to determine whether movement has occurred that may be the result of instruction. The system may also determine from noise levels whether an intrusion may have occurred. If there is a change in the sensors that has been detected, the remote site will notify the control center immediately of the changes and the site will be under an “alarm condition”.

The control enter may then receive still, streaming, or other formats of video feed from a site that is under “Alarm” until the remote site's status can be determined and the situation has been addressed by the operators at the control center. Once the control center confirms that the alarm condition no longer exists, the alarm may be cleared.

The status that the remote site transmits to the control center may also include “ready”, “armed”, or “alarmed” for each partition (comprised of multiple zones) within the remote site. Alarmed refers to a partition in which at least one zone is transmitting an alarm. Armed may refer to a partition in which all the zones are ready to transmit an alarm if one of them should detect movement or traffic. This condition is normally referred to as the “night” condition when the sensor will report any movement or traffic noticed as an alarm. Ready simply refers to the normal status of a sensor, such as during normal daytime operation when some movement and traffic through the zone may be expected and should not be reported, although the signal from the sensor may be monitored by the control center.

Each sensor in a zone within a partition may report one of the following status messages: ready, armed, alarmed, bypass, tamper, open at day time. When ready, the sensor may transmit feed to the control center, but will not sound an alarm. When armed, the sensor will transmit feed and cause an alarm to be transmitted if “open”, i.e., conditions are met which can trigger the alarm. A sensor which is alarmed is detecting a condition that triggers an alarm event. A sensor transmitting a bypass message will not transmit an alarm, regardless of the actual sensor status. This situation may be used for malfunctioning sensors to avoid false alarms. A sensor that is broken may transmit a “tamper” status. An addition message that a sensor may send is “open at day time”, which is a sensor that will only transmit an alarm if that sensor is defined as a “panic button”. A “panic button” is generally a manually alarm that is triggered by an individual during a developing situation, such as a robbery, intrusion, fire, etc.

The control center server provides the operators with the ability to manage a queue of all the sites that are under Alarm. A video feed or still pictures, in jpeg format for example, from each of the remote sites is shown on the server (host) program within the control center. The rest of the sites (if any are not shown on the primary screen display) may be shown as a list of alarm sites. When a site is under an alarm condition, it is preferable that each site in that condition “pop-up” on the primary display screen, to immediately notify the operators of the existence of the condition. Also, it is desirable that the primary display screen identify the status of each remote site being displayed using a color-coded box to outline the video image being displayed in connection with that site. For example, a red outline around the video may appear for a site that is under an alarm condition. A blue outline may appear around a remote site's display when the site has an armed condition. A yellow outline may be used for a “ready in daytime” condition, and a white outline may indicate that a site is not active. Clicking on a remote site in the list of alarmed sites will bring up the video of this site on the screen. This feature will allow the control center operator to monitor whether there is a real alarm or a false one. Additionally, upon receiving an alarm, a map may pop-up or be selectable for the operator that will show the precise location of the alarmed sensor(s) in the remote site. The will allow the operator to guide personnel to that location or to determine the path of the object causing the alarm. To carry out the present invention each remote site will have the remote monitoring software and hardware installed. This is necessary in order to communicate with the control center server. Based on the computing system used by the control center, there may be a limit to the number of sites which each control center can monitor. The limit is based CPU power, bandwidth limitation of the distributed network being used, etc.

One embodiment of the system that may be used in each remote site employs a hardware card in a personal computer and the remote monitoring software. The system may be compatible with any current operating system, however the preferred system is any of windows operating system: win98, WinME, Win2K, WinXP.

By way of example, the limit for a control center to accommodate remote sites with a Pentium 4, 1.7 GHZ with 512 MB of memory is presently 255, assuming sufficient bandwith on the distributed network to accommodate video/audio feed. The number of frames that a site can send (while sending JPEG formatted pictures) depends on the available bandwith of the link between the site and the control center. Each frame may require 64 Kbits of bandwidth, so for an average of 8 frames per second a link of 512 Kbits or ½ Mega bits would be required. The number of frames per site depends also on CPU power, but a low end new PC with 700 Mhz should be sufficient for 8 frames per second.

Another embodiment of the system does not require a personal computer to send the alarm status of the sensors or video feed. The hardware used in this embodiment includes software that is non-platform oriented and can be ported to any hardware that supports TCP/IP connections and optionally video input.

The present system has by 3 basic parts: the server—which is responsible of establishing a data link to the site, the client—which handle all the communication to the site after the link was establish. There is an instance of the client for each site that is connected to the control center, and the control center—The user interface program for the system operators. The communication system used is TCP/IP, preferable, which is very reliable and works well over the Internet without losing packets. Other distributed network protocols may be used.

Each side of the communication (control center and the site) expect to receive a small “I am alive” message periodically, such as every 10 to 20 seconds. If such a message does not arrive, the side that fails to receive the message determines that it should close the link and retry to establish the link again. If the connection is not reestablished, then the site is placed in an alarm state.

When starting the program the control center will run the server application. The server will start listening to messages received from sites. When a request to establish a link is received from a site, the server will notify the control center that will in turn run a new client application. This client application will handle all the communication with the site. The server will send a message to the site, notify it about its “new link” address.

### OPERATION EXAMPLE

Step 1: Wait and listen on port 9700.
Step 2: CONNECTION_REQUEST received? Accept on another Winsock. (To keep the first one free for other requests)
Step 3: If the site does not have an assigned channel already, assign a new one, otherwise use the already assigned.
Step 4: Send the channel number to the site, notify Master about the new attempt.
Step 5: If the connection is closed (Site got the new channel number, will close the connection and attempt a new connection on the new channel), free this Winsock.
Step 6: CLOSE MSG received? Cleanup any open Winsock, exit the program.
   Control Center (Master) Process:
1—Show the GUI Wait for Messages:
2—ADD_CHANNEL received? Read the details from the INI file. Add the site to the list if doesn't exist already. Launch a new “Client” process for this site.
3—Save the handle of the new process so we can send it messages.
4—Send the client its channel number.
5—CHANNEL_STATUS received? Update the status of the link in our database.
6—Update color of the site if this site is currently shown on the screen.
7—FRAME_RATE received? Update the number in our database. Show it on screen if the site is shown on the screen.
8—ALARM_STATUS received? Add the site to the alarm list (If do not exist already), show this site on the screen. Send a “Window handle” message to the client, so the client will start displaying video on the Master screen.
9—Update the color of the site to RED.
10—ALARM_STATUS_ACK received? Remove the site from the alarm list. Remove it from the screen. Send a Zero handle to the client so it will stop showing the video.
11—CLOSE_PROGRAM received? Send a close message to all the clients.
12—Send a close message to the server. Cleanup and exit.
   Client Process:
1—Wait for messages:
2—ADD_CHANNEL received? Start listening on the channel number received in the message.
3—CHANGE_WINDOW_HANDLE received? Update the windows handle to display the video. If its zero—do not display any images.
4—CLOSE_MSG received? Cleanup open Winsock, exit the program.
5—CONNECTION REQUEST received? Accept and wait for data.
6—Data received from the network (Winsock):
7—SMALL_COMMAND_TYPE: Alarm condition on site has been changed. Update master.
8—LAN_ALARM_STATUS_ACK: Alarm site has been cleared—Update master.
9—SEND_BUFFER, SEND_BUFFER_END, SEND_GRAB_FILE, SEND_GRAB_FILE_END:
10—Images (In JPG format) data: If the window video handle is not zero—display the images.
11—I_ALIVE_MSG: Update our internal timer that a msg has been received.
12—If no data is received in 1 minute—close the connection.
   Control Center Subsystem Design

This module serves as the user interface to the control center program. When this program starts, it runs the server and waits for messages. When a site requests to establish a link, the server update the user interface that a new site is trying to communicate. A message is sent from the server to the control center which start a new client process that listens to the new port (97xx, for example) and may be responsible for the communication with the site.

Client Software Subsystem

This program is responsible for the real-time communication between a site and the control center. Each site will have a different instance of this process running. The “master”, i.e., the control center program, will launch this process upon receiving notification from the server that a new link is being established. This process then runs and waits for an “add_channel” message. When the add channel is received, the process start by listening to the winsock on port=channel number. Besides the channel number, the master sends this process a handle to a window. If this handle is 0, no pictures will be displayed otherwise this handle will be used to display the image from the site on this window. The handle might be changed dynamically during the life time of the process, by receiving a new “CHANGE_WINDOW_HANDLE” message with a new handle.

Server—Detailed Communications

The server control listens on a fixed port. This may be, for example, port 9700, to permit a site try to connect. The site may preconfigured on a particular port and ask to start conversation. The server then assigns a free port to continue communicating with the site. As well the server begins a new instance of the client application that listens on this new port (97xx) and may be responsible for the communication with this site. The server updates the user interface that a new site is trying to communicate.

At a low level of the control center, the server is responsible of establishing the link between the control center and the sites. The server's responsibility may include 1) getting a new connection request from a site, 2) allocating new channel to this site, 3) informing the site of the “allocated” number, 4) notifying the master (control center application) about the communication status, and 5) deallocating the channel upon receiving a message from the control center application (when the communication is malfunctioning or ended).

System Overview:

Hardware card—This will generally be a PCI-based card used in a typical personal computer, although customized cards may be created for a variety of platforms and operating system. Such a card may provide video capture and transfer of at least 25 frames per second in NTSC or PAL format, use a rewritable storage media (such as a hard disk driver, random access memory, etc.) and provide video input and output (such as through RCA jacks or other connector). Such a hardware card may also provide a USB interface, PCI interface, or other interface for connecting the card to a computer platform. Additional features might include LAN or WAN connectivity through TCP/IP, Ethernet, ISDN, or other protocols. One preferred method of connectivity is BRI ISDN.

The hardware card may also provide VGA output with at least 320×240 16 color output, although black and white output may be used, depending on the preference and budget of the client system operator. Optimally, the output will be capable of 1024×768 resolution with at least 16 bit color.

Remote Monitoring Software—Control software that interfaces with the hardware card, for controlling a site from the control center should be capable of obtaining video and/or audio feed from the hardware card and transmitting the feed to the control center via a distributed network. Preferably, the network uses a TCP/IP protocol, but other protocols can be configured for use with the present system.

Alarm Review Software (ARS) is a multi-site application that creates a scalable remote video central station. This interface is designed to assist in monitoring large digital video networks operating in multiple locations, allowing users to simultaneously multiple remote sites, anywhere in the world.

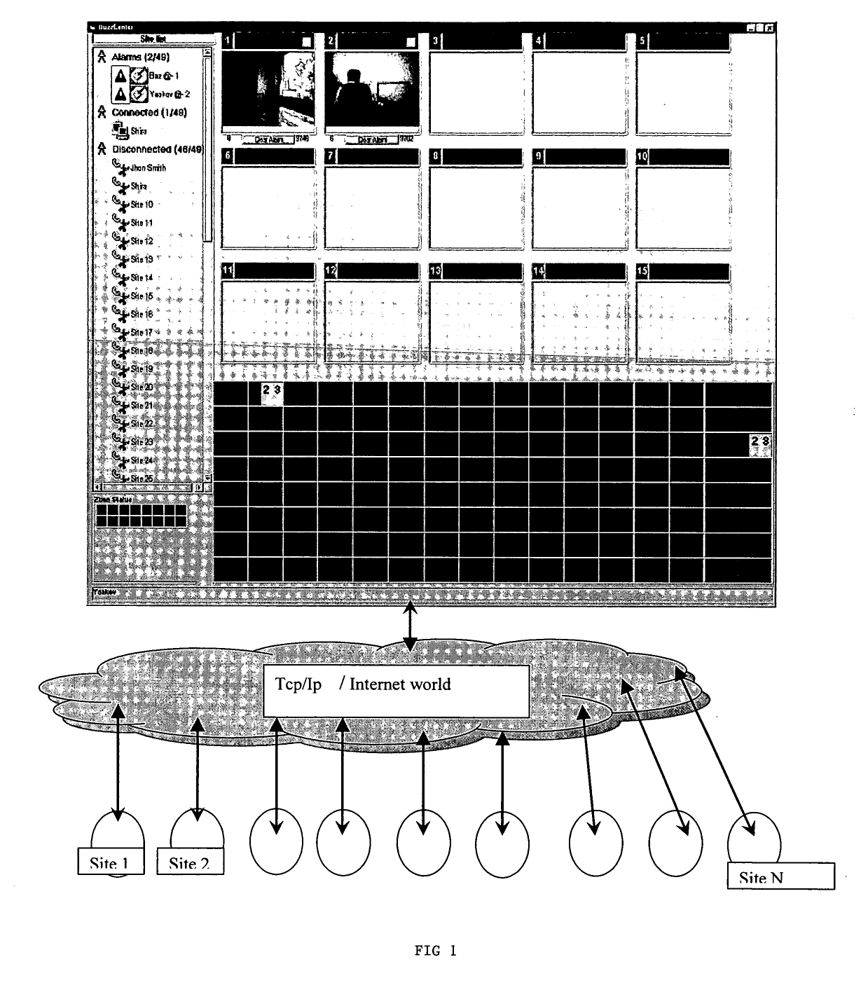

The Alarm Review Software (ARS) component of the present invention permits the operator to review multiple live simultaneous alarm events through the system's Alarm Management module. A depiction of a screen displayed by the server software that enables the operator to view multiple, live feeds simultaneous is shown in FIG. 1. As well, the present system allows the operator to simultaneously review an unlimited number of connected and/or disconnected remote sites, by displaying an alarm indicating that the site is not in contact with the command center.

The features of the ARS may include Multisite Surveillance, wherein a large number of remote sites are simultaneously monitor by only a few operators, thus significantly reducing manpower. The operators may be able to contact law enforcement authorities or other security personnel local to the site being monitored, in the event of unauthorized intrusion or other situations which may develop (fire, equipment malfunction, etc.)

The system may also include a Video Queuing function. In the event of multi video alarms from remote sites, multiple video streams or recordings can be queued for viewing by the operator. As well, the system may include an Event-driven Video with Pre-record Capability. Event-driven video with a pre-record capability allows for the Central Station to capture the person/event causing the alarm, by giving the user access to video captured prior to the conditions being met which triggered the alarm.

To facilitate either video conference features or communication between the control center and local personnel, the system may include Two-way Audio transmission. This allows operators at the Central Station to capture the audio of an event, communicate with facility personnel as the event is occurring or immediately after it has occurred. This feature is especially useful emergency situations, as well as for deterrence.

Automatic Real-time Alarm Generation may also be provided, based on advanced area surveillance and acoustic sensors. When preset conditions are met, such as noise levels, the detection of movement within a video frame, etc., an alarm may be generated that notifies the operator of the condition which set-off the alarm and provide access to the audio and/or video feed associated with the alarm condition.

The system may also provide remote ID verification. This feature of the invention may verify the identify of anyone accessing buildings at unusual hours, for example by using facial recognition software that employs algorithms that match the image of the detected person against faces stored in a database.

Other features of the invention might include real-time bi-directional video/audio conferencing with personnel at site, real-time video to assist with suspect identification and tracking, as visual verification affords improved response time from law enforcement agencies, one-touch image capture, to all the operator to quickly capture an image from a live event with one click of the mouse and quickly print out or e-mail the image for distribution, priority response, which combines manpower and technology.

The present system may also provide full compatibility with various CCTV System, to allow the local user to have full control over the entire system (the central station may reserve ultimate control in an emergency), and can control cameras, VCRs, alarms and other devices (On/Off). A customer can look at multiple sites from their location, using a user-friendly graphical interface.

When the system is operated in dual manned operation mode, a local user can “work” on the system as on any other CCTV system at any established security or productivity. The remote site command center can take control over the system during an event. A local user is not, however, required to be on site. The system can initiate a call due to an alarm or according to a set schedule. The command center can take full control over the system at the remote site. As well, the system can be integrated with alarm devices at the remote site. On-site alarm devices are integrated into the system as a trigger.

1. A method for monitoring the status of events at a remote site, comprising:
establishing a connection between a local host and a client at a remote sites,
providing at least one sensor at the remote site,
monitoring the status of the sensor by the client,
capturing audio, video, or both by the sensor,
transmitting the status of the sensor from the client to the local host,
transmitting audio, video, or both from the client to the local host,
displaying the status of the sensor on a monitor screen by the local host, and
automatically displaying live video feed, still video feed, audio feed, or any combination thereof, in a pop-up window on the monitor screen when an alarm condition has been detected by the sensor.

2. The method of claim 1, wherein the local host establishes connections with clients at a plurality of remote sites.

3. The method of claim 2, comprising queuing video, audio, or both transmitted from the clients at the plurality of remote sites to the local host.

4. The method of claim 1 wherein the pop-up window includes a color-coded outline to indicate the status of the sensor at the remote site.

5. The method of claim 1 wherein the connection between the local host and the client at the remote site is established over a distributed network.

6. The method of claim 5 wherein the distributed network uses the TCP/IP protocol.

7. The method of claim 6 wherein the distributed network is the internet.

8. The method of claim 1 comprising setting an alarm condition when the connection between the local host and the client at the remote site cannot be established.

9. The method of claim 1 comprising determining whether an alarm condition that has been set actually exists by reviewing the audio, video, or both transmitted from the client at the remote site.

10. The method of claim 9 comprising clearing the alarm condition if it is determined from the audio, video, or both that the alarm condition was erroneously set.

11. The method of claim 1 comprising displaying a topographical map of a remote site where an alarm condition has been transmitted to the local host.

12. A system for remote monitoring and surveillance, comprising:
a host computer having server software operating thereon,
a remote terminal at a remote site having client software operating thereon,
a distributed network for transmitting data between the host computer and the remote terminal,
a hardware card installed in the remote terminal for receiving audio and/or video data and status information; and
a sensor for transmitting audio and/or video and status information to the hardware card in the remote terminal,
wherein, the server software installed on the host computer processes information received from the client computer via the distributed network to determine the status perceived by the sensor and displays the status on the screen display, and wherein when the status perceived by the sensor triggers an alarm, the status of the sensor is automatically displayed on the screen display.

13. The system of claim 12 comprising that the server software on the host computer creates a pop-up window on the screen display having a colored outline to indicate that an alarm condition has been met.

14. The system of claim 12 comprising a plurality of sensors installed at a remote site.

15. The system of claim 14 wherein the server software on the host terminal displays a topographical map of the remote site to show the status of the plurality of sensors at the remote site.

16. The system of claim 13 further comprising that the server software on the host computer automatically displays video from a sensor at the remote site when the sensor indicates that an alarm condition exists.

17. The system of claim 16 comprising a colored outline around the video on the screen display to visually indicate the status of the sensor at the remote site.
